(19) United States
(12) Patent Application Publication
(10) Pub. No.: US 2009/0296394 A1
(43) Pub. Date: Dec. 3, 2009

(54) Light emission structure

(76) Inventor: Chih-Yang Wang, San Chung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/318,078

(22) Filed: Dec. 22, 2008

(30) Foreign Application Priority Data
May 30, 2008 (TW) 097209494

(51) Int. Cl. F21V 33/00

(52) U.S. Cl. 362/249.02

(57) ABSTRACT

A light emission structure includes a circuit board and at least one light-emitting diode. The circuit board defines at least one opening, which receives the light-emitting diode therein in such a way that the light-emitting diode has a plurality of terminals extending over and supported by the circuit board and a gap is formed between the light-emitting diode and the opening. As such, heat dissipation of the light-emitting diode is enhanced and overall thickness is reduced.

### FIELD OF THE INVENTION

The present invention relates to a light emission structure, and in particular to a combination of a circuit board and at least one light-emitting diode (LED), wherein the circuit board forms at least one opening receiving the LED therein, for being applied to assembling various light-emitting diodes to a circuit board or backlight panel or the likes.

### BACKGROUND OF THE INVENTION

A conventional light-emitting diode (LED) based light emission structure directly mounts an LED to a circuit board to form a lighting structure or a lighting device. However, the current trend of the high-precision electronic devices is to get compact and slim. When an LED is mounted to a circuit board by being directly stacked to the circuit board, the overall thickness of the light emission structure is increased due to solder being deposited between the terminals of the LED and the circuit board thereby leading to increased overall size, which preventing the light emission structure from being made compact and slim.

When an electrical current flows through the LED, the LED, which is so energized, gives off light and at the same time, generates a great amount of heat, which is transmitted from the terminals of the LED to the circuit board. Such a great amount of heat is often confined within the circuit board and the LED and is difficult to dissipate away. This often makes the LED over-heated and the lifespan thereof is shortened.

To improve the problem caused by the great amount of heat, a heat dissipation device, such as an aluminum-made or copper-made heat dissipation device having a plurality of fins, is employed to facilitate dissipation of heat. Since the LED is soldered to the circuit board, the great amount of heat must be transferred through the circuit board to the heat dissipation device. However, transferring heat through various media may severely affect the final result of heat dissipation, making the performance of heat dissipation worse than expected. A solution to such a problem is thus desired.

In view of the above problems, the present invention aims to provide a light emission structure that overcomes such problems.

### SUMILLIMETERARY OF THE INVENTION

An objective of the present invention is to provide a light emission structure comprising a combination of a circuit board and at least one light-emitting diode, wherein the circuit board defines at least one opening, which receives the light-emitting diode therein in such a way that the light-emitting diode has a plurality of terminals extending over and supported by the circuit board so as to reduce the overall thickness and the overall size of the light emission structure, thereby enhancing the practicability of the present invention.

Another objective of the present invention is to provide a light emission structure comprising a combination of a circuit board and at least one light-emitting diode, wherein the circuit board defines at least one opening, which receives the light-emitting diode therein in such a way that the light-emitting diode has a plurality of terminals extending over and supported by the circuit board to allow the light-emitting diode to be directly attached to a heat dissipation device for greatly enhancing heat dissipation performance of the light-emitting diode and improving the lifespan of the light-emitting diode, thereby enhancing the practicability of the present invention.

A further objective of the present invention is to provide a light emission structure comprising a combination of a circuit board and at least one light-emitting diode, wherein the circuit board defines at least one opening, which receives the light-emitting diode therein in such a way that a gap is formed between the light-emitting diode and the opening to enhance the heat dissipation efficiency of the light-emitting diode, thereby enhancing the practicability of the present invention.

To realize the above objectives, the present invention provides a light emission structure comprising a circuit board and at least one light-emitting diode. The circuit board defines at least one opening, which receives the light-emitting diode therein in such a way that the light-emitting diode has a plurality of terminals extending over and supported by the circuit board and a gap is formed between the light-emitting diode and the opening. As such, efficiency of heat dissipation of the light-emitting diode is enhanced and overall thickness is reduced.

### BRIEF DESCRIPTION OF THE DRAWINGS

The present invention will be apparent to those skilled in the art by reading the following description of preferred embodiments thereof with reference to the drawings, in which:

FIG. 1 is a perspective view illustrating a light emission structure in accordance with the present invention;

FIG. 2 is an exploded view of the light emission structure of the present invention

FIG. 3 is a cross-sectional view of the light emission structure in accordance with the present invention;

FIG. 4 is a schematic plan view illustrating the operation of the light emission structure of the present invention; and

FIG. 5 is a cross-sectional view illustrating a light emission structure in accordance with another embodiment of the present invention.

### DETAILED DESCRIPTION OF THE PREFERRED EMBODIMENTS

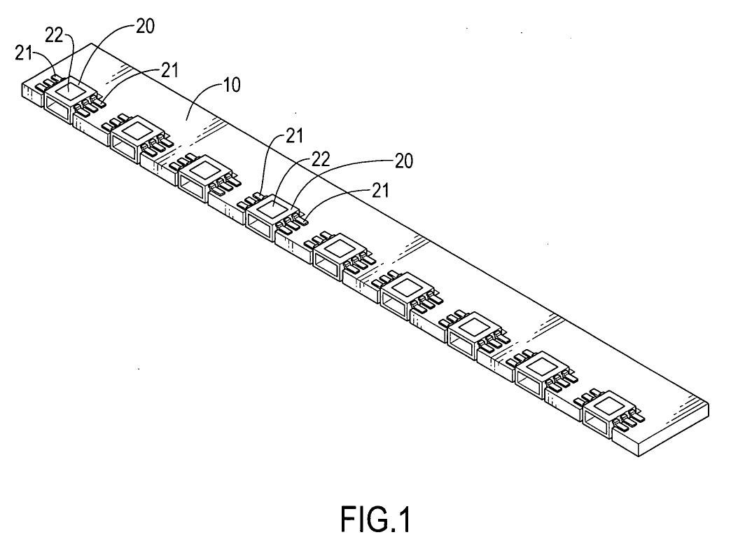

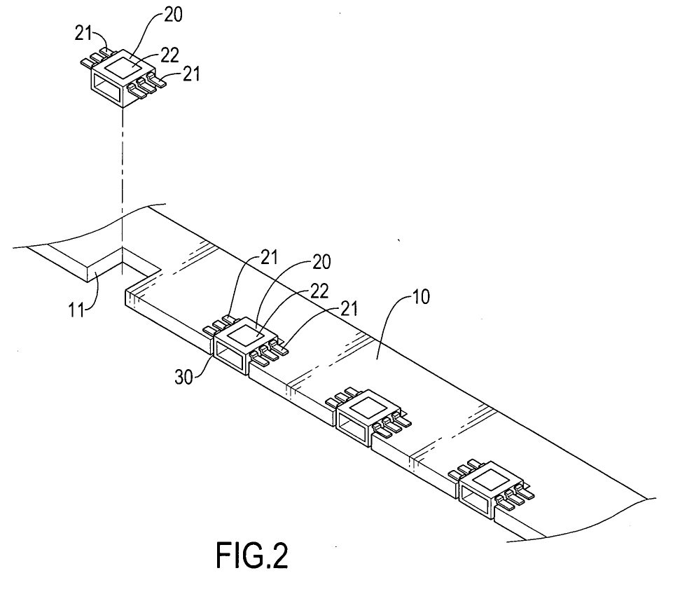

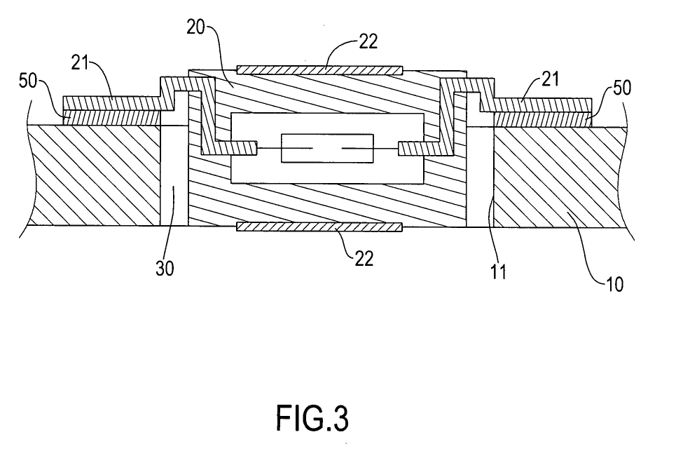

With reference to FIGS. 1-3, the present invention provides a light emission structure, which comprises the following constituent elements/components:

A circuit board 10, which comprises any one of a printed circuit board, an aluminum substrate, a ceramic substrate, and a flexible printed circuit board, forms at least one opening 11. (The circuit board 10 may form a single opening, or as illustrated in the instant embodiment, a plurality of openings 11 is formed in an edge of the circuit board 10.)

At least one light-emitting diode is received in the opening 11 of the circuit board 10. (There may be only one LED 20, or as illustrated in the instant embodiment, a plurality of LEDs 20 is used.) The LED 20 has a plurality of terminals 21, which extends over and is supported by the circuit board 10. Each terminal 21 forms an electrical connection with the circuit board 10 by being soldered thereto with a solder 50. The electrical connection can alternatively be formed by means of metals, including tin, silver, and copper alloy. The LED 20 is received in the opening 11 of the circuit board 10 in such a way that a gap 30 is formed between the LED 20 and the opening 11.

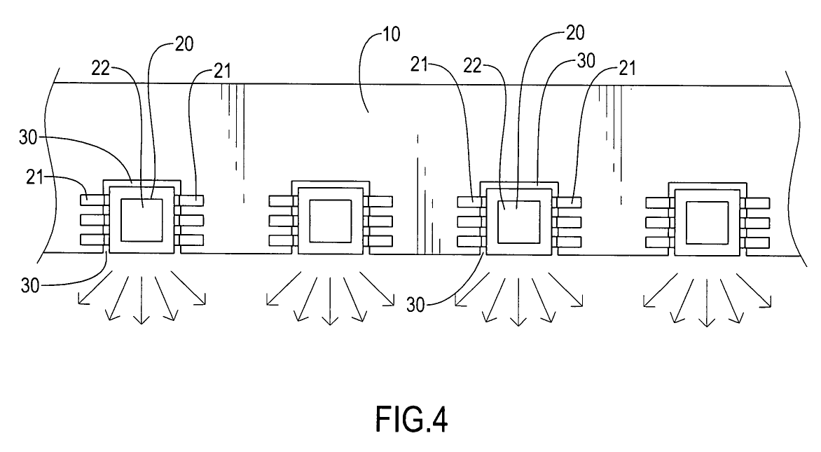

Referring to FIGS. 1, 3, and 4, the circuit board 10 can be a typical printed circuit board, which has thickness of around 0.4 millimeter. The LED 20, which has a thickness of around 0.6 millimeter, is received in the opening 11 of the circuit board 10 with the terminals 21 thereof extending over and supported by opposite sides of the opening 11 of the circuit board 10 and mounted to the circuit board 10 to form electrical connection therebetween. Also, a gap 30 is present between the LED 20 and the circumference of the opening 11 of the circuit board 10 whereby the gap 30 so formed provides effective dissipation of heat from the LED 20. Since the LED 20 is received in the opening 11 of the circuit board 10, the overall thickness of the light emission structure will not substantially increased by the LED 20 being stacked on the circuit board 10. In the instant embodiment, the overall thickness of the light emission structure remains around 0.6 millimeter. Thus, a light emission structure of being compact and slim is provided.

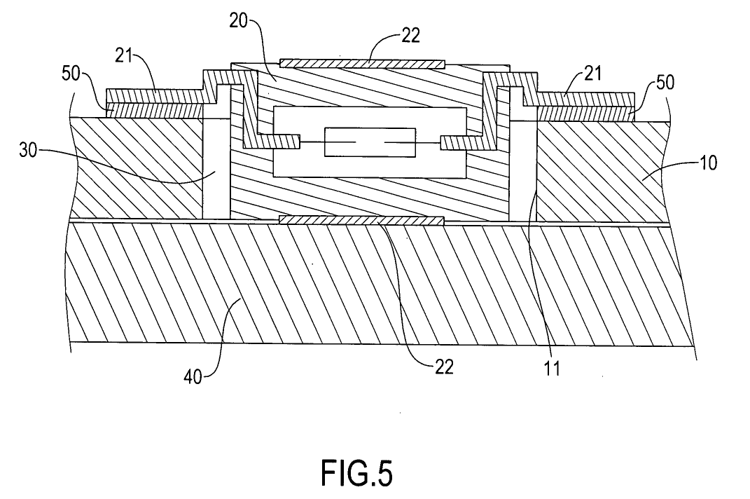

Referring to FIG. 5, which illustrates a cross-sectional view of another embodiment of the present invention, to combine the light emission structure of the present invention with a heat dissipation device 40, or a plurality of heat dissipation devices 40, the LED 20 is provided on a surface thereof with a heat slug 22, which is made of metallic materials of excellent heat conductivity, such as sliver, aluminum, or copper, in such a way that the heat slug 22 is directly attachable to the heat dissipation device 40 for dissipation of heat. Thus, the heat generated by the LED 20 can be directly transferred to the heat dissipation device 40, without being routed through the circuit board 10, whereby the heat dissipation efficiency of the LED 20 can be greatly enhanced.

Referring to FIGS. 1-5, the features of the present invention is a combination of a circuit board 10 and at least one LED 20. The circuit board 10 defines at least one opening, which receives the LED 20 therein in such a way that the LED 20 has a plurality of terminals 21 extending over and supported by the circuit board 10 whereby the overall thickness and size of the entirety of the light emission structure can be reduced due to the LED 20 being received in the opening 11 of the circuit board 10; that a gap 30 is formed between the LED 20 and the opening 11 of the circuit board 10 whereby heat dissipation efficiency of the LED 20 is enhanced by the gap 30 so formed; and that the LED 20 is provided, on a surface thereof with a heat slug 22 that is directly attachable to a heat dissipation device 4o to efficiently transfer heat from the LED 20 to the heat dissipation device 40 for greatly improving the heat dissipation performance of the LED 20 and enhancing the lifespan of the LED 20 thereby improving the practicability of the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A light emission structure, comprising:
a circuit board, which defines at least one opening; and
at least one light-emitting diode, which is received in the opening defined in the circuit board, the light-emitting diode having a plurality of terminals extending over and supported by the circuit board, a gap being formed between the light-emitting diode and the opening.

2. The light emission structure as claimed in claim 1, wherein the circuit board comprises one of a printed circuit board, an aluminum substrate, and a ceramic substrate.

3. The light emission structure as claimed in claim 1, wherein the circuit board comprises a flexible printed circuit board.

4. The light emission structure as claimed in claim 1, wherein each of the terminals of the at least one light-emitting diode forms an electrical connection with the circuit board by being soldered thereto by one of solder, tin, sliver, and copper alloy.
